(19) United States
(12) Patent Application Publication
(10) Pub. No.: US 2017/0065966 A1
(43) Pub. Date: Mar. 9, 2017

(54) MODIFIED CATALYST FOR CONVERTING ORTHO-HYDROGEN TO PARA-HYDROGEN AND METHOD FOR PREPARING THE SAME

(71) Applicant: KOREA INSTITUTE OF SCIENCE AND TECHNOLOGY, Seoul (KR)

(72) Inventors: In Wook NAH, Seoul (KR); Sarng Woo KARNG, Seoul (KR); In Hwan OH, Seoul (KR); Kang Bong LEE, Seoul (KR); Jung Hyun KIM, Seoul (KR)

(73) Assignee: KOREA INSTITUTE OF SCIENCE AND TECHNOLOGY, Seoul (KR)

(21) Appl. No.: 15/258,143

(22) Filed: Sep. 7, 2016

(30) Foreign Application Priority Data
Sep. 7, 2015 (KR) 10-2015-0126562

(51) Int. Cl. B01J 29/072; C01B 3/00; B01J 35/02; B01J 35/04; B01J 35/06

(52) U.S. Cl. CPC B01J 29/072; B01J 35/04; B01J 35/06; B01J 35/026; C01B 3/0089; B01J 2229/20

(57) ABSTRACT

Disclosed are a modified catalyst for converting ortho-hydrogen to para-hydrogen, in which a metal active material capable of converting ortho-hydrogen to para-hydrogen is coated on a surface of a porous support, a method for preparing the same, and an apparatus and a method for converting ortho-hydrogen to para-hydrogen in hydrogen gas using the same. Accordingly, a pressure drop may be prevented and impurities in hydrogen gas may also be simultaneously removed when ortho-hydrogen is converted to para-hydrogen, and a stable reaction operation may be enabled.

### CROSS-REFERENCE TO RELATED APPLICATION

This application claims the priority of Korean Patent Application No. 10-2015-0126562, filed on Sep. 7, 2015, and all the benefits accruing therefrom under 35 U.S.C. §119, the contents of which in its entirety are herein incorporated by reference.

### BACKGROUND

1. Field

The present specification relates to a catalyst for converting ortho-hydrogen to para-hydrogen in hydrogen gas and a method for preparing the same, and more particularly, to a modified catalyst capable of converting ortho-hydrogen to para-hydrogen by modifying a surface of a support such as zeolite etc. with an active material, a method for preparing the same, and a method for converting ortho-hydrogen to para-hydrogen in hydrogen gas using the same.

2. Description of the Related Art

Hydrogen has inherent characteristics of being composed of ortho-hydrogen and para-hydrogen at a ratio of 3:1 at a normal temperature (300 K), and the ratio of ortho-hydrogen and para-hydrogen in hydrogen needs to be changed according to a purpose of utilizing hydrogen such as for a preparation of liquefied hydrogen.

In this regard, a technology of synthesizing a hydrous ferric oxide powder using ferric chloride and sodium hydroxide, and the like in the related art has been proposed.

However, according to an observation by the present inventors, a catalyst produced by this method has fine particles, so that there exists a problem in which when the hydrogen gas passes through the catalyst, a pressure drop (P) occurs and the catalyst becomes a barrier against a material transfer. The pressure drop and the like may increase a consumption of energy, thereby increasing its preparation costs. Further, since impurities such as moisture etc. remain in hydrogen gas, a reactor clogging phenomenon frequently occurs, which in turn acts as a factor suppressing its actual on-site application.

### SUMMARY

In an aspect, the present disclosure is directed to providing a modified catalyst for converting ortho-hydrogen to para-hydrogen, which may prevent a pressure drop and may also simultaneously remove impurities in hydrogen gas when ortho-hydrogen is converted to para-hydrogen, an apparatus and a method for converting ortho-hydrogen to para-hydrogen, including the modified catalyst, and a method for preparing the modified catalyst.

In other aspect, the present disclosure is directed to providing a modified catalyst for converting ortho-hydrogen to para-hydrogen, which simultaneously has a high para-hydrogen conversion ratio while having effects such as the aforementioned prevention of a pressure drop, an apparatus and a method for converting ortho-hydrogen to para-hydrogen using the modified catalyst, and a method for preparing the modified catalyst.

In exemplary embodiments, provided is a modified catalyst for converting ortho-hydrogen to para-hydrogen in hydrogen, including: a porous support; and a metal active material provided on a surface of the porous support, in which the metal active material is capable of converting ortho-hydrogen to para-hydrogen.

In an exemplary embodiment, the metal active material is a metal oxide.

In an exemplary embodiment, a metal of the metal oxide is one or more selected from a group consisting of iron (Fe), ruthenium (Ru), chromium (Cr), molybdenum (Mo), tungsten (W), gadolinium (Gd), neodymium (Nd), europium (Eu), and holmium (Ho).

In an exemplary embodiment, the porous support is one or more selected from a group consisting of zeolite, alumina, silica, activated carbon, zirconia, and titania.

In an exemplary embodiment, the porous support is zeolite.

In an exemplary embodiment, the porous support is represented by the following Chemical Formula 1.

xM[(Al₂O₃)ₓ(SiO₂)_{y}]zH₂O [Chemical Formula 1]

(M is an ion of monovalent or divalent alkali or alkaline earth metals capable of exchanging ions, and n denotes a valence of the ion. x and y denote the coefficient of a metal oxide and silica, respectively, and z denotes the number of water of crystallization. x is 1˜2, y/x is 10˜100, z is 0˜10)

In an exemplary embodiment, the metal oxide is iron oxide and has an amorphous phase.

In an exemplary embodiment, a weight ratio of the active material is 0.01 to 70 wt % with respect to the entire modified catalyst.

In an exemplary embodiment, the modified catalyst is in a form of at least one selected from a group consisting of granule, bead, fiber, and honeycomb.

In an exemplary embodiment, the metal active material is provided on the support by ion exchange.

In an exemplary embodiment, the catalyst prevents a pressure drop when hydrogen gas passes through the catalyst.

In an exemplary embodiment, the catalyst is capable of removing impurities when hydrogen gas passes through the catalyst.

In exemplary embodiments, provided is an apparatus for converting ortho-hydrogen to para-hydrogen in hydrogen, comprising the modified catalyst.

In an exemplary embodiment, the apparatus is an apparatus for preparing liquefied hydrogen.

In exemplary embodiments, provided is a method for converting ortho-hydrogen to para-hydrogen in hydrogen using the modified catalyst.

In an exemplary embodiment, the hydrogen to be converted is one or more of a gas and a liquid.

In an exemplary embodiment, the hydrogen to be converted is provided to and reacted on the modified catalyst, and is reacted under a temperature from a normal temperature (300 K) to an extremely low temperature (14 K).

In exemplary embodiments, provided is a method for preparing a catalyst for converting ortho-hydrogen to para-hydrogen in hydrogen, the method including: introducing a metal ion capable of converting ortho-hydrogen to para-hydrogen into a porous support; and oxidizing the porous support into which the metal ion is introduced.

In an exemplary embodiment, the method comprises: immersing a porous support in a metal precursor solution capable of providing a metal ion to introduce the metal ion into the porous support through ion exchange; and forming a metal oxide on a surface of the porous support by subjecting the porous support into which the metal ion is introduced to a heat treatment to oxidize the porous support.

In an exemplary embodiment, the porous support into which the metal ion is introduced is dried and washed, and then a heat treatment is performed under an air atmosphere.

In an exemplary embodiment, the porous support and the metal precursor solution are allowed to flow through a tube, and the metal precursor solution is allowed to flow in a direction opposite to the porous support.

In an exemplary embodiment, the ion exchange is performed in a temperature of a normal temperature to 200° C., a reaction pressure of 1 to 300 atm, and a reaction time of 0.1 second to 24 hours.

In an exemplary embodiment, the heat treatment temperature is 150 to 1,000° C.

In an exemplary embodiment, the heat treatment temperature is 150 to 200° C.

According to exemplary embodiments of the present disclosure, a pressure drop may be prevented and impurities in hydrogen gas may also be simultaneously removed when ortho-hydrogen is converted into para-hydrogen. Accordingly, a stable reaction operation may be enabled. Further, it is possible to provide a modified catalyst which simultaneously has a high para-hydrogen conversion ratio while having effects such as prevention of a pressure drop as described above. Exemplary embodiments of the present disclosure may be usefully used for a process of preparing liquefied hydrogen.

### BRIEF DESCRIPTION OF THE DRAWINGS

The above and other aspects, features and advantages of the disclosed example embodiments will be more apparent from the following detailed description taken in conjunction with the accompanying drawings in which:

FIG. 1A illustrates a 3-dimensional SEM of a catalyst in which the surface of zeolite is modified with iron oxide.

FIG. 1B enlarges a portion marked with circle in FIGS. 1A and is an EDS line analysis of the concentration profile of iron components.

FIG. 10 illustrates an enlarged EDS line analysis result for the concentration profile of iron components.

FIG. 2 is a hysteresis loop illustrating a change in magnetic properties of the modified catalyst according to the heat treatment temperature in the present Example.

FIG. 3 is a graph illustrating an ortho-para hydrogen spin conversion according to the heat treatment temperature of the modified catalyst (Fe-modified zeolite) in the present Example.

FIG. 4 is a graph illustrating a correlation by measuring a value of a pressure drop according to the change in flow rate of hydrogen gas in order to compare the pressure drop of a commercially available catalyst (iron oxide, Molecular Products) which is a comparative example and that of the modified catalyst in the Example.

### DETAILED DESCRIPTION

Exemplary embodiments are described more fully hereinafter. The invention may, however, be embodied in many different forms and should not be construed as limited to the exemplary embodiments set forth herein. Rather, these exemplary embodiments are provided so that this disclosure will be thorough and complete, and will fully convey the scope of the invention to those skilled in the art. In the description, details of features and techniques may be omitted to more clearly disclose example embodiments.

The terminology used herein is for the purpose of describing particular embodiments only and is not intended to be limiting of the invention. As used herein, the singular forms “a,” “an” and “the” are intended to include the plural forms as well, unless the context clearly indicates otherwise. Furthermore, the use of the terms a, an, etc. do not denote a limitation of quantity, but rather denote the presence of at least one of the referenced item. The terms “first,” “second,” and the like do not imply any particular order, but are included to identify individual elements. Moreover, the use of the terms first, second, etc. do not denote any order or importance, but rather the terms first, second, etc. are used to distinguished one element from another.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

### DEFINITION OF TERMS

In the present disclosure, the ortho-hydrogen means a hydrogen of which two atoms constituting a hydrogen molecule have the same spin direction.

In the present disclosure, the para-hydrogen means a hydrogen of which two atoms constituting a hydrogen molecule have the opposite spin directions.

For reference, hydrogen is composed of 75% ortho-hydrogen and 25% para-hydrogen at a normal temperature in the atmospheric pressure, the ratio is slowly changed according to the temperature, and when a specific catalyst (a metal active material to be described below) is used, the specific catalyst reacts with hydrogen, and thus, the conversion rate is increased. Since para-hydrogen is more stable and has a lower energy level than ortho-hydrogen, ortho-hydrogen needs to be quickly converted into para-hydrogen in order to convert the hydrogen gas into the liquid.

In the present disclosure, the conversion of ortho-hydrogen to para-hydrogen means that one atom of the two atoms of ortho-hydrogen having the same spin direction is changed to have an opposite spin direction (i.e., spin conversion). For example, it is known that ortho-hydrogen may be converted to para-hydrogen by a change in the magnetic force etc. around the hydrogen molecule.

In the present disclosure, a metal active material means a metal material (catalyst) capable of converting ortho-hydrogen to para-hydogen.

In the present disclosure, a modified catalyst or a surface modification means that the surface of a support which supports the catalyst is coated with an active material capable of converting ortho-hydrogen to para-hydrogen.

The surface of the support of the present disclosure includes not only the surface at the outer side of the support, but also the surface at the inner side of the support. That is, for example, in the case of a porous support, the surface of the support also means including the surfaces of the pores present at the inner side of the support.

In the present disclosure, the pressure drop means that pressure drops when hydrogen gas passes through the catalyst.

In the present disclosure, impurities in hydrogen gas mean moisture and gas or liquid, and the like other than hydrogen, and being able to remove impurities means that the porous support may adsorb impurities to prevent impurities from being accumulated on a metal active material (catalyst).

In the present disclosure, a metal precursor solution means a solution capable of providing a metal ion to the support.

In the present disclosure, an apparatus for converting ortho-hydrogen to para-hydrogen includes a catalyst for converting ortho-hydrogen to para-hydrogen and means various devices or articles, such as a reactor for converting ortho-hydrogen to para-hydrogen.

### Description of Exemplary Embodiments

Hereinafter, exemplary embodiments of the present disclosure will be described in detail.

In exemplary embodiments of the present disclosure, provided is a modified catalyst for converting ortho-hydrogen to para-hydrogen in hydrogen, including: a porous support; and a metal active material provided on a surface of the porous support, in which the active material is capable of converting ortho-hydrogen to para-hydrogen, and an apparatus for converting ortho-hydrogen to para-hydrogen, which includes the same.

In an exemplary embodiment, the active material may be a metal oxide.

The metal of the metal oxide may be one or more selected from the group consisting of iron (Fe), ruthenium (Ru), chromium (Cr), molybdenum (Mo), tungsten (W), gadolinium (Gd), neodymium (Nd), europium (Eu), and holmium (Ho).

Further, the porous support may be one or more selected from the group consisting of zeolite, alumina, silica, activated carbon, zirconia, and titania, and is preferably zeolite. Examples of the zeolite may include a synthetic zeolite such as ZSM-5, A, X, Y, high silica zeolite, sodalite, modernite, clinoptilolite, faujasite, and bentonite, or a natural zeolite.

In a non-limiting example, the porous support zeolite may be represented by the following Chemical Formula 1.

xM[(Al₂O₃)ₓ(SiO₂)_{y}]zH₂O [Chemical Formula 1]

Here, M denotes a metal ion capable of exchanging ions, and n denotes a valence of the ion. x and y denote the coefficient of a metal oxide and silica, respectively, and z denotes the number of water of crystallization. Herein, x may be 1˜2, y/x may be 10˜100, z may be 0˜10.

In a non-limiting example, M may be an ion of monovalent or divalent alkali or alkaline earth metals.

In an exemplary embodiment, the weight ratio of the active material is 0.01 to 70 wt % with respect to the entire modified catalyst. When the weight ratio is less than 0.01%, the conversion ratio of para-hydrogen is low, and when the weight ratio is more than 70%, the surface may not be easily modified.

In an exemplary embodiment, the form of the modified catalyst may be one or more selected from the group of granule, bead, fiber, honeycomb forms (the form of the porous support may be granule, bead, fiber, or honeycomb). The particle size of granule or bead may be in a range of 0.1 to 50 mm, and is preferably a spherical form with a particle size of 1 to 5 mm. When the particle diameter of the crystal of the support such as zeolite is excessively small, the pressure drop (P) may be increased during a catalytic reaction, and when the particle diameter is excessively large, the surface area may be decreased, so that the amount of an active metal oxide catalyst to be introduced may be decreased.

The catalyst according to exemplary embodiments may be in a form that a metal active material capable of converting ortho-hydrogen into para-hydrogen is introduced into the surface of the support, and may prevent the pressure drop when hydrogen gas passes through the catalyst. Further, it is possible to remove impurities when hydrogen gas passes through the catalyst. The conventional catalyst is in a form of fine powders with a particle size of several to several tens um (micrometer) units, and thus when hydrogen gas passes through the catalyst, a pressure drop occurs, the flow of hydrogen gas is not smooth, and a clogging phenomenon occurs. In addition, at an extremely low temperature, a small amount of moisture or impurities are accumulated on the catalyst, thereby hindering the flow of hydrogen gas. The porous support adsorbs moisture or impurities, and thus is able to be used for longer period of time than the conventional catalysts, and also prevent the pressure drop.

The catalyst according to exemplary embodiments may be applied to various apparatuses such as a reactor for converting ortho-hydrogen to parat-hydrogen. These apparatuses may be very usefully used, for example, for the process of preparing liquefied hydrogen. Therefore, exemplary embodiments of the present disclosure further provide an apparatus for preparing liquefied hydrogen, including the above-described modified catalyst for converting ortho-hydrogen to para-hydrogen.

Exemplary embodiments of the present disclosure also provide an apparatus and a method for converting ortho-hydrogen to para-hydrogen in hydrogen using the modified catalyst.

In an exemplary embodiment, the hydrogen to be converted is one or more selected from a gas and a liquid. The hydrogen to be converted is provided to and reacted on the modified catalyst, and may be reacted under a temperature condition from a normal temperature (300 K) to an extremely low temperature (14 K).

Exemplary embodiments of the present disclosure also provide a method for preparing a catalyst for converting ortho-hydrogen to para-hydrogen in hydrogen, the method including: introducing a metal ion capable of converting ortho-hydrogen to para-hydrogen into a porous support; and oxidizing the porous support into which the metal ion is introduced.

In an exemplary embodiment, the method may include: immersing a porous support in a metal precursor solution capable of providing a metal ion to introduce the metal ion into the porous support; and forming a metal oxide on a surface of the porous support by subjecting the porous support into which the metal ion is introduced to a heat treatment to oxidize the porous support.

Explaining further in detail each step of the method, first, it is possible to introduce one or more metal ions selected from the group consisting of, for example, iron (Fe), ruthenium (Ru), chromium (Cr), molybdenum (Mo), tungsten (W), gadolinium (Gd), neodymium (Nd), europium (Eu), holmium (Ho), and the like into the above-described porous support such as zeolite etc. through ion exchange or impregnation. Accordingly, it is possible to convert the catalyst into a modified form where the surface of the porous support is modified (for example, Fe-zeolite).

In a non-limiting example, a transparent and uniform solution may be obtained, for example, by mixing one or more of precursor materials having the above-described metal ion with an appropriate solvent in order to introduce the metal ion into the porous support. An ion exchange may be performed by mixing the obtained metal precursor solution with the above-described porous support such as zeolite or ceramic bead, etc. and impregnating the resulting mixture at a normal temperature or higher temperature.

Subsequently, ions exchange is performed by impregnating the porous support in the metal precursor solution at a normal temperature or higher temperature. Herein, the porous support may be put into the metal precursor solution, and mixed with each other while being stirred.

In a non-limiting example, the mixing process may be performed in either a batch or a continuous mode. Further, the mixing process may also be performed by arranging a porous support such as zeolite etc. in a form of a fixed layer, for example, in a tubular reactor, and pumping a metal precursor solution for the porous support such as zeolite etc. in a liquid or in a slowly flowing mode (trickle mode), and circulating the metal precursor solution or linearly passing the metal solution precursor solution through the porous support.

In addition, in a non-limiting example, the porous support such as zeolite etc. and the metal precursor solution may be allowed to flow through a tube, and it is also possible to allow the solution to flow in a direction opposite to the porous support such as zeolite etc. The ion exchange may be performed in one or more filter reactors, and a downstream filter solution may be recirculated in the previous filter reactor. Further, the ion exchange may be performed in a combination of one or more stirred tanks or one or more flowing tubes and one or more filter reactors continuously and in the opposite direction.

In a non-limiting example, the ion exchange may be performed under the reaction conditions of a temperature of a normal temperature to 200° C., a pressure of 1 to 300 bar, and a reaction time of 0.1 second to 24 hours. The reaction at high temperature may enhance the mobility of the metal salt to allow the metal salt to reach deep micropores of the porous support such as zeolite etc., thereby providing a high loading efficiency.

In a non-limiting example, the metal content of the porous support such as zeolite may be set to 0.1% to 70% based on the weight by ion exchange in order to synthesize an effective modified catalyst. For the concentration of the metal precursor solution, it is possible to use a solution at a concentration of 0.1 wt % to solubility limit, preferably 5 to 35 wt %.

In this manner, the metal precursor solution and the porous support such as ion-exchanged zeolite may be separated through filtration or centrifugation. The modified catalyst coated with the metal active material is finally obtained on the support by filtering or centrifuging the metal ion-exchanged support, and then drying and washing the support, and performing a heat treatment under the air atmosphere.

In a non-limiting example, it is possible to use one of, for example, EDS, XRF, XRD, and ICP in order to measure the amount of ion-exchanged metal after the drying (for example, drying at 100° C.), and the ion-exchange process may be repeated two to three times in order to increase the weight ratio. In order to remove salts other than metals attached to the zeolite, the zeolite may be washed with water, for example, one to five times. For the amount of water, for example, 1 to 1,000 g of water per 1 g of zeolite may be used.

In a non-limiting example, the heat treatment after drying may be performed in a temperature range of, for example, 150 to 1,000° C. (preferably 150 to 200° C. in terms of catalyst activity), and for example, for 30 minutes to 5 hours.

Hereinafter, the specific Example according to exemplary embodiments of the present disclosure will be described in more detail. However, the present disclosure is not limited to the following Example, and various forms of examples can be implemented within the accompanying claims, and it should be understood that the following Example only completes the disclosure of the present disclosure and simultaneously allows a person with ordinary skill in the art to easily carry out the present disclosure.

### Example

100 ml of a 10% aqueous solution of FeCl₃ (Junsei) is ion-exchanged in 50 g of a support of zeolite (Wako, 1.40 to 2.36 mm) at a stirring speed of 200 rpm at 45° C. for 3 hours. In order to remove unreacted iron and chlorine ions, the support is washed with distilled water through a filter. A catalyst of which the surface is modified with iron oxide is prepared by drying the support at 100° C. and performing a heat treatment (calcination, sintering) at 200° C., 300° C., 400° C., and 500° C., respectively for 3 hours.

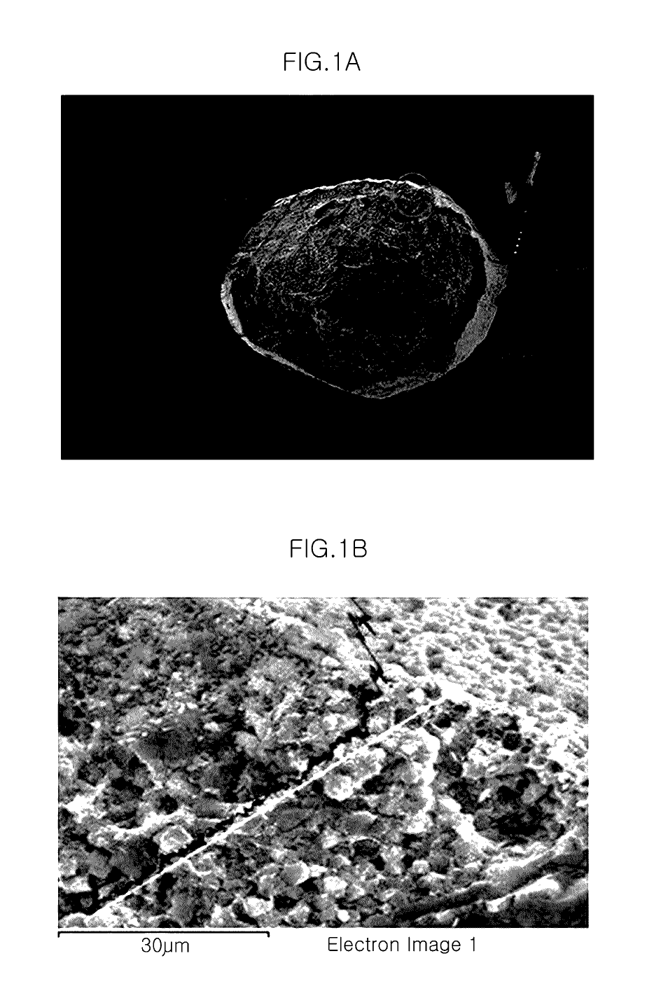

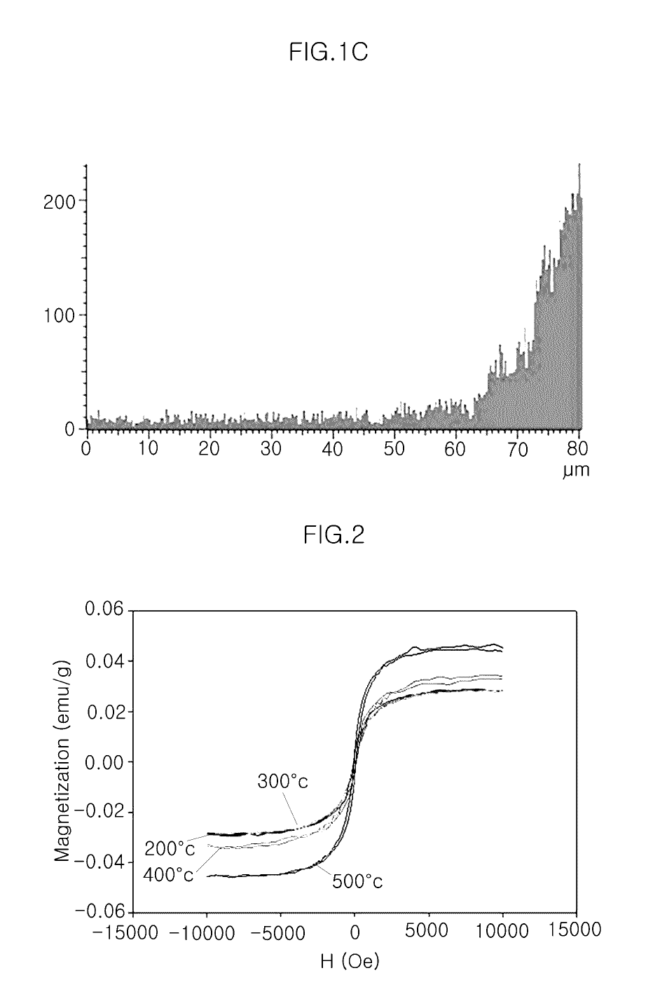

FIG. 1 is SEM and EDS results for confirming whether a metal oxide is coated on the surface of a support of a modified catalyst (the metal oxide is present in an amount of 20 wt % in the entire modified catalyst) in the Example of the present disclosure.

Specifically, FIG. 1A illustrates a 3-dimensional SEM of a catalyst (iron oxide coated zeolite) in which the surface of zeolite is modified with iron oxide (the catalyst subjected to heat treatment at 200° C.).

FIG. 1B enlarges a portion marked with circle in FIG. 1A and illustrates an analysis result (EDS line analysis) of the concentration profile of iron components. It can be seen that iron components are coated on the surface.

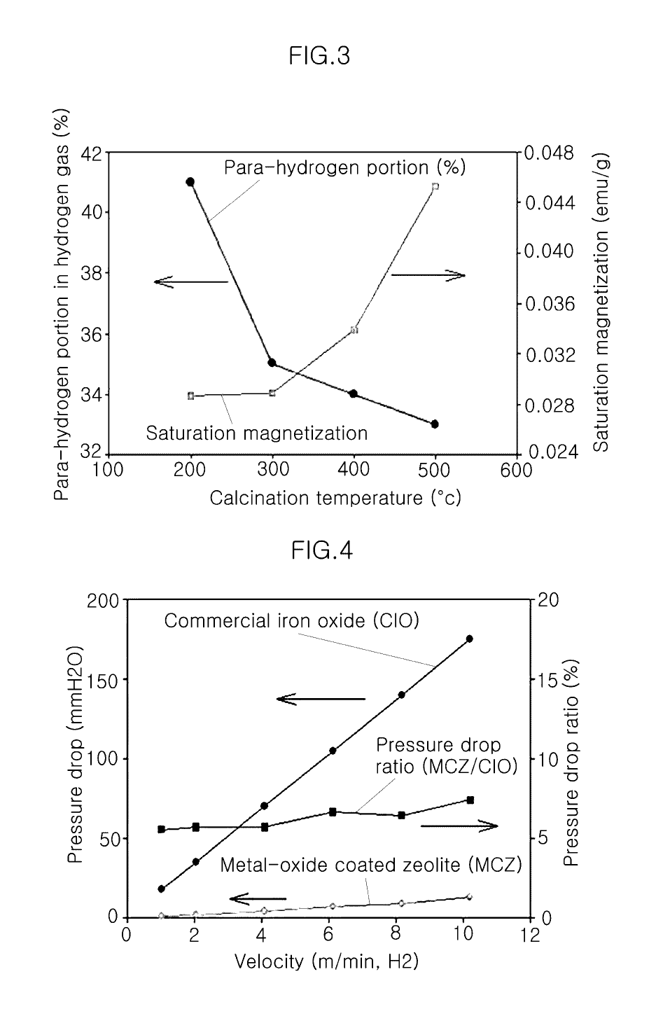

FIG. 1C enlarges the concentration profile of iron components (EDS line analysis). From FIG. 10, it can be confirmed that the concentration of iron components on the surface is high.

Hydrogen is passed through the modified catalyst (iron oxide coated zeolite). The ratio of para-hydrogen is measured under the condition of a space velocity of 2,000 (1/hr) at a reaction temperature of 77 K.

Meanwhile, as for a comparative example, an experiment is performed under the same condition using a commercially available catalyst (trade name: Ionex Type O-P catalyst, component Fe₂O₃, and manufacturer: Molecular Products).

TABLE 1

| | Ratio (%) | |
|---|---|---|
| | of para- | |
| Classification | hydrogen | Remarks |
| Comparative Example | 40 | Reaction Temperature |
| Commercially Available | | 77 K. |
| Catalyst | | Space velocity 2,000 |
| Example Modified Catalyst | 40 | (1/hr) |
| (200° C. Heat Treatment) | | |
| Example Modified Catalyst | 35 | |
| (300° C. Heat Treatment) | | |
| Example Modified Catalyst | 34 | |
| (400° C. Heat Treatment) | | |
| Example Modified Catalyst | 33 | |
| (500° C. Heat Treatment) | | |

Reference: the ratio of para-hydrogen in hydrogen at a normal temperature (300 K) is 25%.

Meanwhile, in order to examine the effects of heat treatment temperature on the magnetic properties of the modified catalyst material prepared, the hysteresis loop of the heat-treated sample is measured by a vibrating sample magnetometer (VSM) by varying the temperature within 200° C. to 500° C.

FIG. 2 is a hysteresis loop illustrating a change in magnetic properties of the modified catalyst (Fe-modified zeolite) according to the heat treatment temperature in the present Example.

Further, Table 2 shows the magnetic properties (Ms, Mr, and Hc) and the BET surface area according to each temperature. Ms denotes the saturation magnetization, Mr denotes the remnant magnetization, and Hc denotes the coercivity.

TABLE 2

| Temperature | BET | Ms | Mr | Hc |
|---|---|---|---|---|
| (° C.) | (m²/g) | (emu/g) | (emu/g) | (Oe) |
| 200 | 15 | 0.0287 | 0.0036 | 7.08 |
| 300 | 14 | 0.0289 | 0.0048 | 7.08 |
| 400 | 13 | 0.0339 | 0.0050 | 9.08 |
| 500 | 13 | 0.0453 | 0.0058 | 9.08 |

From the above data, it can be seen that as the heat treatment temperature is increased from 200° C. to 500° C., the saturation magnetization (Ms) and remnant magnetization (Mr) values are increased. It is thought that this increase in magnetization is due to an increase in particles size and the resulting decrease in surface area.

Meanwhile, FIG. 3 is a graph illustrating an ortho-para hydrogen spin conversion according to the heat treatment temperature of the modified catalyst (Fe-modified zeolite) according to the heat treatment temperature in the present Example.

As can be seen from this, the activity (ortho-para hydrogen conversion efficiency) of the modified catalyst at a heat treatment temperature of 200° C. is remarkably high. The high activity is thought to be because the modified catalyst surface material iron oxide has an amorphous phase at a low heat treatment temperature of 200° C. Specifically, since paramagnetic characteristics are exhibited rather than ferromagnetic characteristics as in FIG. 2 on the aforementioned amorphous phase, it is thought that the high spin conversion ratio is measured.

Therefore, it is preferred that the heat treatment is performed at 150 to 200° C. in terms of the catalyst activity.

FIG. 4 is a graph illustrating an experimental result of comparing the pressure drop of the modified catalyst of an Example (catalyst subjected to heat treatment at 200° C.) with the pressure drop of the comparative example of commercially available catalyst. A glass tube with a height of 30 cm and an inner diameter of 1 cm is filled with the catalyst in a depth of 20 cm, and then the flow rate of the hydrogen gas is increased to 1 to 10 m/min. In the graph, the modified catalyst in Example is marked with a metal-oxide coated zeolite (MCZ), and the commercially available catalyst is marked with a commercial iron oxide (CIO).

As illustrated in FIG. 4, in the case of the commercially available catalyst (CIO), the pressure drop is greatly increased to 18 to 175 mmH₂O, whereas the pressure drop of the modified catalyst (MCZ) is measured as low as 1 to 13 mmH₂O under the same condition. It can be seen that the pressure drop value of the modified catalyst exhibits about 7% of the commercially available catalyst, which is a very low value.

Therefore, it can be seen that the modified catalysts of exemplary embodiments of the present disclosure have a remarkable effect of preventing the pressure drop.

What is claimed is:

1. A modified catalyst for converting ortho-hydrogen to para-hydrogen in hydrogen, comprising:
a porous support; and
a metal active material provided on a surface of the porous support,
wherein the metal active material is capable of converting ortho-hydrogen to para-hydrogen.

2. The modified catalyst according to claim 1, wherein the metal active material is a metal oxide.

3. The modified catalyst according to claim 2, wherein a metal of the metal oxide is one or more selected from a group consisting of iron (Fe), ruthenium (Ru), chromium (Cr), molybdenum (Mo), tungsten (W), gadolinium (Gd), neodymium (Nd), europium (Eu), and holmium (Ho).

4. The modified catalyst according to claim 3, wherein the porous support is one or more selected from a group consisting of zeolite, alumina, silica, activated carbon, zirconia, and titania.

5. The modified catalyst according to claim 4, wherein the porous support is zeolite.

6. The modified catalyst according to claim 1, wherein the porous support is represented by the following Chemical Formula 1.
xM[(Al₂O₃)ₓ(SiO₂)_{y}]zH₂O [Chemical Formula 1]
(M is an ion of monovalent or divalent alkali or alkaline earth metals capable of exchanging ions, and n denotes a valence of the ion. x and y denote the coefficient of a metal oxide and silica, respectively, and z denotes the number of water of crystallization. x is 1˜2, y/x is 10˜100, z is 0˜10.)

7. The modified catalyst according to claim 1, wherein the metal oxide is iron oxide and has an amorphous phase.

8. The modified catalyst according to claim 1, wherein a weight ratio of the active material is 0.01 to 70 wt % with respect to the entire modified catalyst.

9. The modified catalyst according to claim 1, wherein the modified catalyst is in a form of at least one selected from a group consisting of granule, bead, fiber, and honeycomb.

10. The modified catalyst according to claim 1, wherein the metal active material is provided on the support by ion exchange.

11. The modified catalyst according to claim 1, wherein the catalyst prevents a pressure drop when hydrogen gas passes through the catalyst.

12. The modified catalyst according to claim 1, wherein the catalyst is capable of removing impurities when hydrogen gas passes through the catalyst.

13. An apparatus for converting ortho-hydrogen to para-hydrogen, comprising the modified catalyst according to claim 1.

14. The apparatus according to claim 13, wherein the apparatus is an apparatus for preparing liquefied hydrogen.
